(19) United States
(12) Patent Application Publication
(10) Pub. No.: US 2008/0192114 A1
(43) Pub. Date: Aug. 14, 2008

(54) Wearable waterproof camera

(76) Inventors: Kent D. Pearson, Antelope, CA (US); Melanie A. Pearson, Antelope, CA (US)

Correspondence Address: Robert M. Ashen, Esq., 1737 Franklin Canyon Drive, Beverly Hills, CA, 90210-1622, US

(21) Appl. No.: 12/069,269

(22) Filed: Feb. 8, 2008

Related U.S. Application Data
(60) Provisional application No. 60/900,539, filed on Feb. 9, 2007.

(51) Int. Cl. H04N 5/225; G03B 17/08

(52) U.S. Cl. 348/81; 396/25; 348/E05.024

(57) ABSTRACT

A wearable, waterproof or water-resistant digital camera. The camera may be combined with a sport or athletic device such as swimming or diving mask or goggles. The frame for the goggles may also provide a waterproof housing that has internal compartments for camera-related elements or components. One or more compartments may be openable to afford user access as for changing a battery or memory card. One or more compartments may be permanently sealed, which minimizes risk of the water leaking in. “Access” to the permanently sealed compartment can then be achieved by use of a separate, external control or operating unit such a one using wireless technology. In one presently preferred form, the frame may have sides that are located adjacent to the temples of the user, which lowers and redistributes the weight of the device.

### RELATED APPLICATIONS

This application is a continuation-in-part, and claims priority from US provisional application 60/900,539 by the same inventors, filed Feb. 9, 2007, and which is incorporated by reference in its entirety.

### FIELD OF USE

This invention relates to wearable waterproof or water-resistant cameras, and more particularly to such cameras designed for use with goggles or other sports or athletic equipment used in connection with activities that involve exposure to wind, water or immersion.

### BACKGROUND

Digital cameras have been incorporated into various modern-day devices such as cell phones and PDAs.

However, there are certain specific requirements for a camera that (1) can be worn by the participant in a sports or athletic activity so that the hands of the participants are free to participate in the activity, and (2) can withstand exposure to water as in the case of submersion or even heavy rain.

Having the camera supported by a safety strap is desirable, but it does not really free the hands of the participant to be fully involved in the sports activity. Thus, it would be highly desirable to have a device that would allow the participant full and free use of her hands for the activity, while supporting the camera for easy and ready picture-taking when desired.

It would also be highly desirable that the camera be protected from water as when the camera is immersed in water as when the wearer is swimming, or simply exposed to water as a heavy rain as when the wearer is running, biking, water skiing, mountain climbing, skiing, water boarding, steering a motor boat or the like.

In achieving the goal of protecting the camera from water or moisture, it is desirable that the camera-related elements or components be separated from the water as by being in sealed compartments.

There are several waterproofing approaches. One approach is to use one or more compartments that are normally sealed when closed, but that can be opened by the user to access such things as memory cards, batteries, or USB ports. The access provided is desirable, but having a cover that can be opened creates some potential leakage problems: the cover may not be fully closed, the seal on the cover may wear or be damaged, the cover might deteriorate, etc. Having the compartment permanently sealed at the factory so that the user cannot open it avoids the leakage problems but limits access that the user may want or need. Some of the access issues can be resolved using wireless technology. In this connection, various functions associated with a camera might be achieved in a wireless manner using separate, external operating or control means. The camera could be actuated by operating means in the form of an external wireless actuator mechanism. Similarly, data such as photograph files could be transferred in a wireless manner by operating means to an external computer or printer. Rechargeable batteries could be recharged by use of operating means in the form of an external recharging platform. All of this would avoid the necessity for access openings to the areas containing the camera components; this in turn would avoid the risk of water reaching the components inadvertently through such access openings. The user's needs and desires also come into play. For example, when operating off a small boat or hiking, wireless technology may not be available so that access to change batteries and/or memory cards may be highly desirable.

To Applicants' knowledge such needs, desires, goals and possible solutions for a wearable waterproof camera have not been adequately reconciled or achieved by prior art devices.

There are prior art devices that use the broad concept of a waterproof camera combined with a diving mask or goggles. Several such prior art devices are disclosed in U.S. Pat. No. 6,181,644 and US published application No. US2005/0237386. The disclosures of such patent and application are very limited and sketch in terms of just how the camera-related elements or components are housed, accessed, and/or operated. For example, there is no disclosure of whether compartments housing the elements are permanently sealed or openable by the user, whether and/or how things might be accomplished remotely by wireless technology, how the elements are positioned to balance and distribute weight, etc.

Accordingly, there is an unsatisfied need for an improved waterproof camera device that can be worn by a participant in a sports or outdoor activity where there is significant exposure to water.

### SUMMARY

The present invention provides an improved wearable, waterproof or water-resistant camera utilized in conjunction with sports, recreation and exploration in environments that expose devices to water, such as outdoor and underwater sports.

One illustrated preferred embodiment is in the form of a waterproof digital camera combined into one unit with an athletic, sport or recreational device such as a swimming mask or goggles. The camera-related elements or components are contained and supported in compartments in a waterproof housing that also provides the frame for the mask. This preferred embodiment is characterized by having at least one openable compartment and one permanently sealed compartment. Those compartments contain the camera-related elements or components such as a circuit board, an image sensor, one or more batteries, a memory card and an actuating mechanism. At least one of the compartments is normally sealed, however, it may be openable by the user to access the elements in the compartment to change a battery and/or a memory card, or do a repair. At least one other compartment is permanently factory sealed (as defined below) so that it is not directly accessible by the user; in such case, “access” may be had by separate, external operating means as discussed above.

Another illustrated preferred embodiment is characterized by having at least one sealed compartment that is selectively openable by the user to access the compartment interior. If desired, all camera-related elements could be in such an openable compartment or compartments.

Yet another illustrated preferred embodiment is characterized by having at least one permanently sealed compartment. If desired, all camera-related elements could be in such a permanently sealed compartment or compartments.

In the illustrated swimming mask, the frame/housing may be composed of a plastic. The illustrated mask has a skirt or gasket of silicon or rubber to keep the mask air tight on the face. The housing/frame combines the camera and mask into one product. The plastic housing may contain insert molded elastomer material to allow for flexibility and to provide a water barrier over buttons or levers that may be depressed or moved to actuate the internal camera components. Rubber or elastomer gaskets may be positioned around such buttons or levers to seal any openings that could allow fluid to penetrate any internal compartments. The illustrated mask provides one or more viewing windows or panes in front of the wearer's eyes. The camera lens is on the frame, at the forehead, in line with the nose, and just above the eyes. The eyes are not obstructed with this positioning. The close proximity of the lens to the eyes allows the user to record an image that is similar to what is in the user's field of vision. By use of the cross hairs on the goggles a user may approximate the image that will be recorded when the camera button is pressed or activated. This avoids the need and cost of providing an internally visible display of the image to be taken or that has been taken that the user can view when wearing the device.

The illustrated camera has internally viewable means such as an LED that changes colors and/or blinks to tell the user various things such as when the camera is turned on, the mode that it is in, and when a still photo or a series of photos are taken. The modes may include single-shot (red), multi-shot video (green), and delete (amber) modes. The illustrated camera may also have one or more externally operable control buttons or switches: for various functions such as for turning the camera on and off, for selecting a mode, for taking a picture or pictures(video), for focusing the camera, for deleting a picture, etc. The illustrated device may also have a large external LED on the outside of the mask to indicate information to others such as when a photo is taken. A sound emitting device may also be activated when a picture is taken. A LED or sound emitting device may also be used to indicate to the user when the memory card is full.

Further an externally readable LCD or another counting indicator may be added to the outside of the mask. This can tell the user (when the camera mask is removed from the face) the number of images that have been taken, and/or the number of images that can still be added to the memory. The LCD may also indicate other functions such as the mode of use the camera is in, remaining battery life, data transfer information. etc.

The outer surface of the control buttons may be an insert molded elastomer material to give the buttons flexibility while remaining waterproof. Elastomer material may also be used to water proof a latch that covers an openable compartment containing components such as batteries and/or a port for connecting to devices such as a USB connector.

The mask may have a rechargeable battery unit which connects to an electrical outlet for recharging the battery. When an appropriate portion of the mask is in contact with the recharging unit, the battery may be recharged without the requirement of opening the camera housing, inserting any external connectors or having metal electrical contacts on the outside of the housing. Similar types of recharging units are used in electric toothbrush devices where water is at risk of entering any openings in the device and it is advantageous to have a battery that may recharge without removing parts or inserting plugs into the unit.

Similarly, data such as files containing photos may be transferred to and from the camera by separate, external operating means such as wireless units.

A separate, external operating means in the form of a wireless activator may be used to signal the camera to take a picture. This activator may be supported on the user as by being mounted on a wrist band, a necklace, a ring, a clamp, a belt or a glove to be worn by the user. The activator may include a button or member that can be depressed by a finger or a finger and thumb. This allows alternative modes of activating the camera with less motion of the limbs, which is desirable when capturing images of sea life. Sudden motions may frighten off fish or cause a current that moves plant life. Additionally an activator that requires less motion will aid the user in swimming or other activities. When a swimmer moves a limb they will have to move the other limbs to counter act the motion and steady themselves in the water. The ease of use of the camera or decreased motion will improve the user's safety as less attention is placed on the activation of the camera device and the stabilizing of self in the water, so that more focus will remain on water safety, noticing the surrounding environment and proper swimming or water treading techniques.

Use of a separate, external operating or control means for recharging the battery, data transfer and/or camera activation allows some or all camera-related elements to be permanently sealed. Permanently is used to describe factory sealing that is not intended or required to be opened by the user. It may be achieved as by an O-ring, an adhesive, a gasket, or sonic welding between sections of the housing. The permanent seal might in fact be re-opened at the factory or by an authorized person for repair or maintenance.

An alternative embodiment includes the camera as a separate water proof unit that may snap on, slide on or similarly attach to a mask of various proportions or qualities. The camera may be configured to snap on to multiple brands of masks using plastic or rubber components. The camera housing may also be designed to connect with just one design of a mask that may be configured with groves, hooks, rails or another form that allows the secure attachment of the camera housing to the mask. This embodiment of the camera mask allows the mask to be configured into multiple sizes and of various materials to allow a broad spectrum of users to purchase a mask that will suit their needs of mask size, material quality and price point that they prefer. This may also allow multiple users to buy their own mask and share the camera device. In this case a family may have for example three different sizes of masks and they may choose to share one camera while on vacation. A user may wish to take higher quality images to create larger prints while another user may prefer a lower price point. The device may include multiple levels of camera components to suit different needs. This interchangeable unit allows a user to create their own camera mask where the user defines the level of quality and price for either the camera unit or for the mask that suits their needs.

The mask may also contain an MP3 device that works with waterproof ear plugs that are inserted into the users' ears. The sound may be transmitted to the ear plugs by wireless transmission or by use of a waterproof electrical cord. Alternatively the mask may have waterproof speakers to emit sound close to the user's ears.

The device may include a sound recording device to capture audio with an image or with a video. A non-permeable microphone component may be added to the underwater camera components contained in the waterproof housing. This is desirable for explorers or scientists to record their findings with regards to location, temperature, time of day or any other readings that may aid their research. This is also desirable as an amusement feature as the muffled sound of speech underwater entertains children and adults in addition to aiding the capture of the overall feel of the underwater experience.

In an alternative embodiment, the camera components are housed in a water proof unit that may be worn directly on the head by use of a strap or band that secures the item during athletic activities. This embodiment is ideal for use with smaller goggles worn by swimmers. This embodiment has additional uses as the strap or band may fit over or around a protective helmet or a hat used for outdoor sports. The materials used to waterproof the camera may help to cushion the camera components under rugged use in addition to making the camera ideal in rainy weather or in situations. This embodiment is ideal where the user may be active both on land and in water such as a tri-athlete.

In another presently preferred embodiment the configuration of the frame or housing has been varied to provide side extensions located at the temples of the wearer. These extensions may provide compartments as for housing batteries. This wrap-around configuration of the frame achieves a lowering and spreading out of the weight of the device on the head of the wearer. In one form, an underwater light may be located on one side of the frame and the batteries on the other side.

### BRIEF DESCRIPTION OF THE DRAWINGS

FIG. 1 is a frontal view of the preferred embodiment

FIG. 2 is a top view of the preferred embodiment

FIG. 3 is a perspective view of a preferred embodiment

FIG. 4 is a perspective view of the embodiment of FIG. 1

FIG. 5 is a perspective view of the embodiment of FIG. 1

FIG. 6 is a perspective view of the embodiment of FIG. 1

FIG. 7 is a perspective view of the embodiment of FIG. 1

FIG. 8 is a perspective view of the embodiment of FIG. 1

FIG. 9 depicts a wireless activator of an alternate embodiment

FIG. 10 is a perspective view of an alternate embodiment

FIG. 11 is a perspective view of the embodiment of FIG. 1 further including a sound transmission device

FIG. 12 is a perspective view of the embodiment depicted in FIG. 1 illustrating placement on wearer's head

FIG. 13 is a perspective view of the embodiment of FIG. 1 further illustrating attachable features

FIG. 14 is a perspective view of an alternate embodiment

FIG. 15 is a perspective view of FIG. 1 further illustrating connection to an image output device

FIG. 16 is a perspective view of an alternate embodiment

FIG. 17 is a perspective view of an alternate embodiment

FIG. 18 is a side view of the embodiment depicted in FIG. 1

FIG. 19 is a perspective view of another preferred embodiment.

FIG. 20 is a rearview of the embodiment of FIG. 19.

FIG. 21 is a perspective view of a portion of the embodiment of FIG. 19.

FIG. 22 is a perspective view of another embodiment.

FIG. 23 is a perspective view of the embodiment of FIG. 19 having an underwater light.

### DETAILED DESCRIPTION OF THE PREFERRED EMBODIMENT

Several presently preferred embodiments of wearable waterproof or water resistant cameras according to the present invention are described in reference to the accompanying drawings.

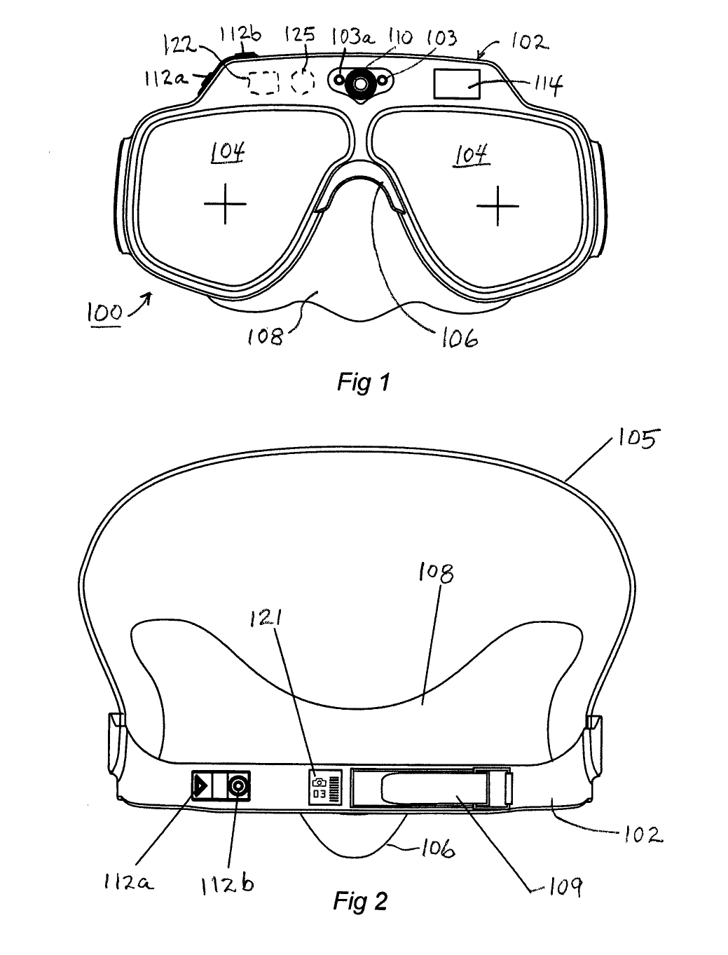

Refer initially to FIGS. 1-5 and 7 which show an integrated unitary wearable waterproof imaging device or camera 100 wherein the components of a digital camera are contained and supported in a waterproof housing 102 that also provides the frame for a mask or goggles.

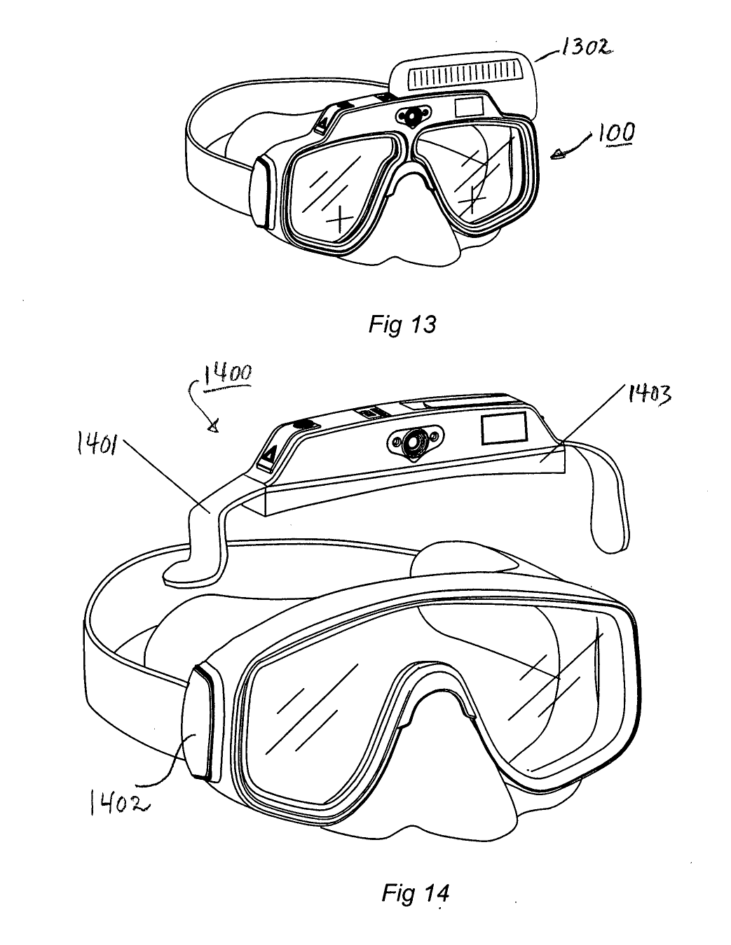

The illustrated wearable imaging device 100 includes a frame or housing 102 configured, proportioned and arranged to be removably mounted on the head of the wearer as shown best in FIGS. 12 and 18. The frame 102, when so mounted, is generally disposed in front of the upper portion of the head of the wearer. The illustrated frame 102 includes a gasket 108 and a nosepiece 106 which contribute to forming and providing an enclosed area around the eyes and nose of the wearer that is sealed from and protected from the surrounding water or moisture. The illustrated frame 102 includes a pair of eye windows or coverings 104 of transparent glass or plastic that are located in front of the eyes of the wearer to allow the wearer to view the surroundings in front of her as suggested in FIG. 18.

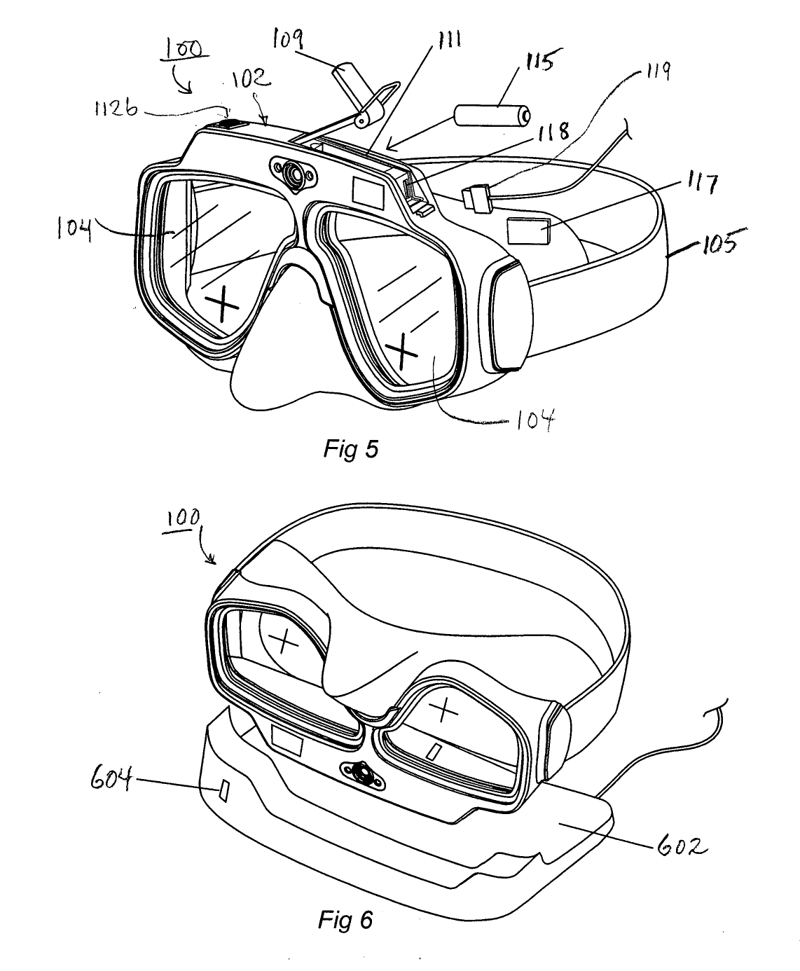

The illustrated frame 102 supports and/or houses various camera-related elements or components of the device. Such elements include standard, commercially available digital camera components such as a lens 110, a micro-processor chip 122, a printed circuit board (PCB) 120, a camera digital image sensor 126 and, camera controls 112a, 112b. The illustrated elements may also include other standard and commercially available elements such as an internally viewable LED 113 (FIG. 4), a large externally viewable LED or flash 114, a small externally viewable LED 103, a small externally viewable infrared sensor 103a, and an externally readable LCD screen 121 on the top of the frame102. The illustrated frame 102 provides an integrated normally closed and sealed, but openable, compartment 111 (see FIG. 5) for receiving and electrically connecting to a standard removable battery 115 and a standard removable memory card or stick 117. The illustrated compartment 111 may also be opened to provide access to a USB port 18 that releasably connects to by a USB connector 119 on a data transferring cable that leads to a PC or a printer.

The illustrated device 100 may also include a standard commercially available sound-receiving microphone 125 located within the housing 102 and connected to the microprocessor 122 for recording sounds to accompany the pictures being taken.

As shown in the drawings, when the device 100 is mounted on the wearer, the eye coverings or windows 104 are disposed generally in front of the eyes of the wearer while the portion of the frame 102 that supports and houses the imaging device components is positioned generally above the eye windows 104 and extending across the fore head of the wearer. The camera may capture individual still images or a series of images (video).

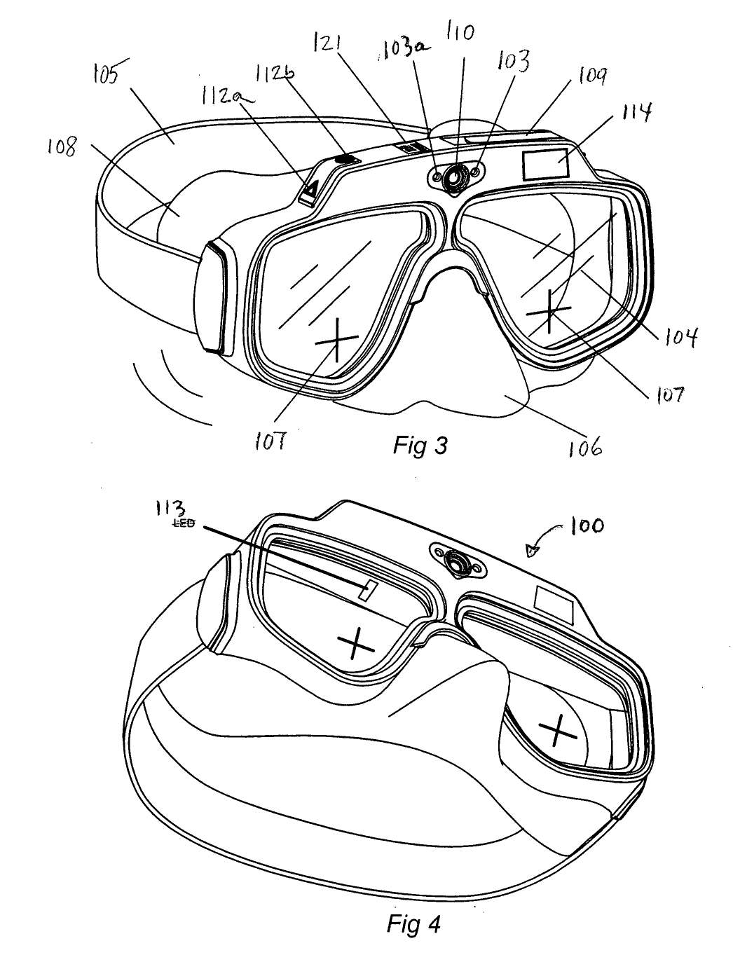

FIG. 2 is a top view of a device 100 of FIG. 1 and includes a strap 105, and the skirt or gasket 108, both of plastic and/or elastomeric materials, to aid in the wearing of the device. FIG. 2 also shows the controls 112 as including an on/off-mode button 112b and a focus/select/shutter button 112a. The outer surface of the buttons may be an insert molded elastomeric material to give the image controls 112 flexibility (e.g. controls can be easily pressed) while remaining waterproof. Also depicted in FIG. 2 is a water proof latch 109 for the compartment 111 (beneath said latch and depicted in FIG. 5) that, according to the design and functionality of the device, contains camera-related elements such as the batteries 115 and/or the USB port 118 for connecting to devices such as a USB connector 119 on the data transfer cable. This figure illustrates the lever or button, focus/select/shutter button 112a, along the upper surface of the frame 102 that activates the components to record an image. An LCD display 121 may be positioned on the frame 102 to indicate information such as the number of images taken, amount of memory available, remaining battery charge or the mode of use (ex. “single image mode, infrared mode, etc.).

FIG. 3 is a perspective view of the wearable imaging device or camera 100 of FIGS. 1 and 2. The illustrated frame 102 may be made of plastic while the skirt or gasket 108 may be composed of elastomeric materials, such as silicon or rubber to keep the device air tight on the face. The frame 102 that combines the imaging device with features of protecting the wearers eyes from exposure to elements such as water, rain, snow and/or wind. The cross hairs 107 on the eye covering 104 may be permanent affixed or may be on removable vinyl decals. It can be appreciated that the positioning of the lens 110 may vary in any portion of the frame 102, although generally is preferable oriented towards a direction in which the wearer's eyes may be directed. LED lights may be included to indicate when an image is taken. Moreover, the device may emit a clicking sound to indicate an image capture event has occurred.

FIG. 4 is a perspective view illustrating the inside of the device 100 of FIG. 1 that comes in contact with the wearer. The device may feature an indicator, such as an LED indicator light 113, that blinks on the interior of the frame to indicate only to the user or wearer of the device when an image is taken. This is contrast to an external image indicator that may signal to others than the wearer that an image is being or has been taken.

FIG. 5 is a perspective view of the camera 100 of FIG. 1, illustrating the water proof latch 109 in the open position, which reveals the inner compartment 111 fashioned to accommodate various camera-related elements. The compartment 111 may also house a battery or batteries 115. There may also be a slot for a removable memory card 117 which would allow for transfer of media files as well as the ability to increase the memory capacity of the camera. This figure also illustrates elements which allow the user to transfer media files. Such illustrated elements are a USB connector 119 on the end of a cable that can plug into a USB port 118 located in the compartment 111. The USB cable could also be used to provide power to recharge a rechargeable battery.

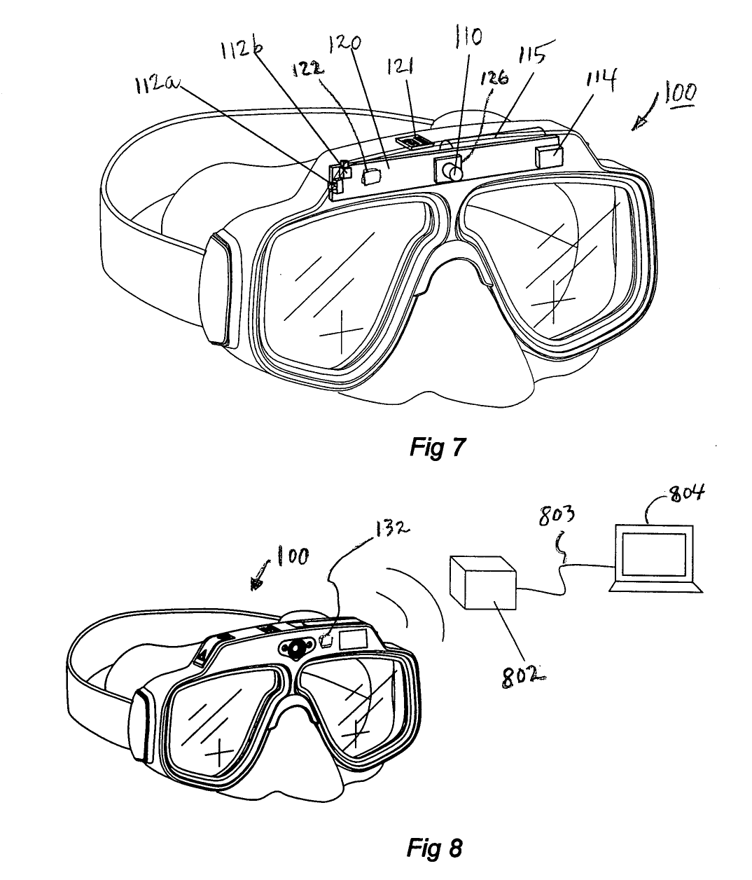

FIG. 6 is a perspective view of the device 100 of FIG. 1, illustrating that the device 100 may have a standard, commercially available battery recharging unit 602 which is connected to an electrical outlet. When an appropriate portion of the device 100 is in physical contact with the recharging unit, the battery may recharge without the requirement of opening the housing 102 to remove and replace the battery, without inserting any external connectors, or having external metal electrical contacts. External metal electrical contacts are undesirable and could be dangerous. Using this technology, the battery may be in a permanently sealed compartment. The technology utilizes an electromagnetic field. A light 604 may indicate when charging is completed. Similar types of recharging units are used in electric toothbrush devices where water is at risk of entering any openings in the device and it is advantageous to have a battery that may recharge without removing parts or inserting plugs into the unit.

FIG. 7 is a perspective view of the device 100 of FIG. 1, illustrating the internal image capture components housed inside the housing 102. These components may or may not be visible depending on the transparency of the housing102. A raised portion of the housing 102 houses the lens 110, electronic printed circuit board (PCB) 120, the microprocessor chip 122, and the battery 115. This section of the housing may also house lights, infrared, LCD components or any connectors that would be used to transfer digital files from a digital media device to a computer, display device, printer or other media handling apparatus.

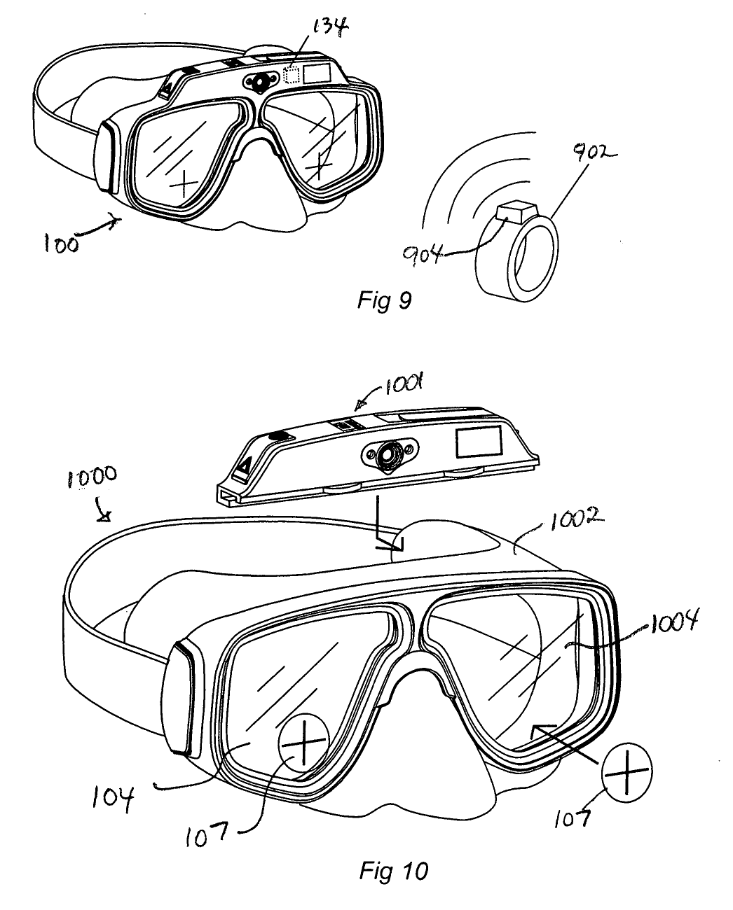

FIG. 8 is a perspective view of the device 100 of FIG. 1, illustrating a separate, external control or operating means such as a wireless transmission system for downloading image-containing data files from the camera. The device 100 may include a standard, commercially available transceiver or transmitter 132 which can transmit image files as by means of Wi-fi, infrared or Bluetooth to a standard wireless receiver 802. The receiver 802 may be connected as by a cable 803 to a destination device 804 such as a computer, display unit, or image reproduction device. The transmitter 801 might also transmit directly to a destination device 804 that has a built-in receiver (not shown).

As depicted in FIG. 9, a separate, external operating or controlling means in the form of an external wireless activator 902 may be used to signal the device 100 to initiate image capture. Such an activator 902 may be incorporated into a wrist or arm band, a belt, a ring, a clamp, a glove or other article that could be worn or carried by the user. The activator 902 may include a user movable member such as a depressible button 904 that could be operated by the user. This allows alternative modes of activating the device with minimum limb movement. The activator 902 may be in the form of a short range RF transmitter that sends an electrical signal to a standard receiver 134 in the in the camera housing. The signal then goes to the camera micro-processor which turns on the image-capturing sensor to take the picture.

For use in conditions other than full submersion, voice activation is also an alternative.

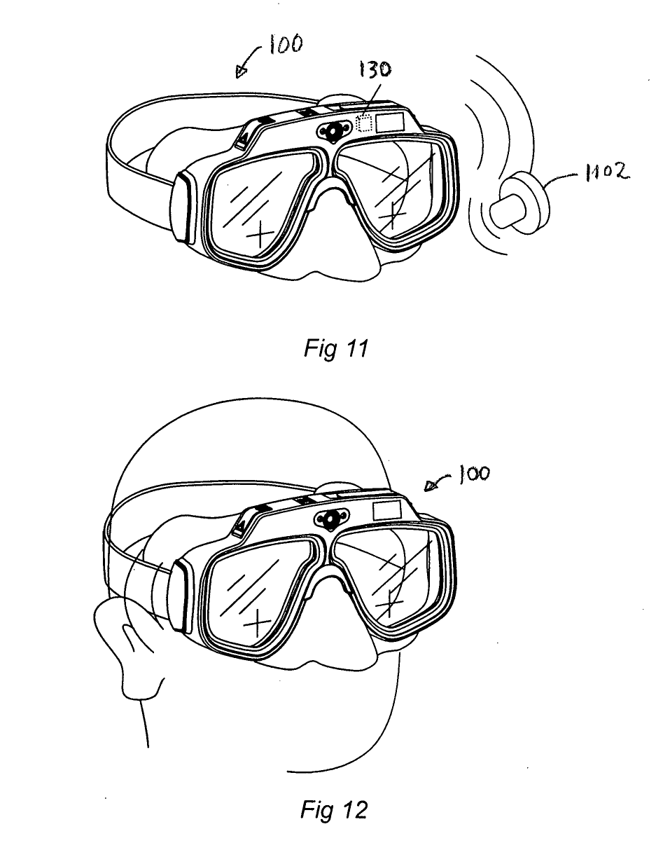

FIG. 10 is a perspective view of an alternative embodiment comprising a modular system 1000, where the image capture device or camera 1001 is a separate water proof unit that may snap on or attach to head-adapted gear 1002 such as eye-protective head-gear of various proportions or qualities, where a design feature of the head-gear 1002, or some intermediate coupler (not depicted), provides secure connection of the image capture device 1001 and some head-adapted gear 1002. The modular system allows multiple sizes of users to use the image capture device. Further, the modular system 1000 enables users to select head-gear of varying quality and price, and to transfer the image capture device between sets of head-gear. This may also allow multiple price points of the image taking device so that the user may upgrade the lens, functions or memory components. This modular system 1000 and its interchangeable features allow a user to create their own system according to price, fashion and performance criteria.

Also depicted in FIG. 10, the cross hairs 107 on the eye-covering 104 may be printed on removable decal that adhere to the covering. This allows a user to peel the crosshairs 107 off of the mask if they should desire, once they are familiar with the field of view of the image capture device; or to transfer the cross-hairs 107 to other head-gear for use with the system 1000; or simply to change cross-hairs as fashion elements.

FIG. 11 is a perspective view of the device 100 of FIG. 1 illustrating that the device may also contain a standard commercially available MP3 player 130. The player may work with one or two wireless, waterproof ear plugs 1102 that are inserted into the user's ears or may be connected to the ear plugs by a waterproof electrical cord (not shown).

FIG. 12 is a perspective view of the device 100 of FIG. 1, illustrating it's placement on a user's head, positioned over the face. This illustration shows that the mask may also contain an MP3 device with a sound emitting device contained close to the ear without the need to have a device inserted into the ear.

FIG. 13 is a perspective view of the device 100 of FIG. 1, illustrating that the device may be adapted to receive attachable elements 1302 such as lights or a flash. The attachable element 1302 would snap on, slide on or similarly be able to be securely attached to the device 100 if desired, or removed when it is not needed.

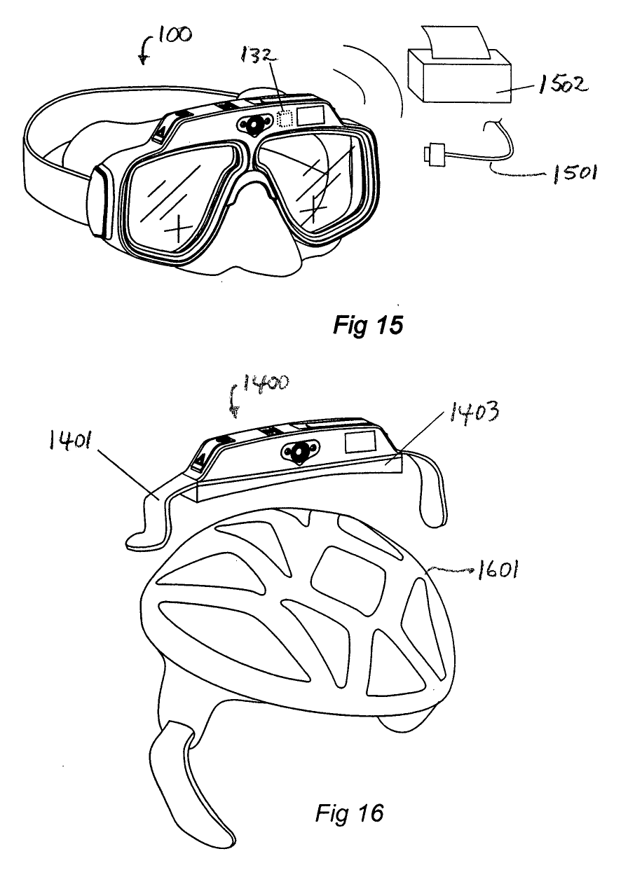

FIG. 14 is a perspective view of an alternative embodiment, where the device 1400 is modular and includes fasteners 1401 such as straps, clamps or devices which allow the imaging device 1400 to securely attach to a rim and or straps located on the head-gear 1402. The imaging device 1400 may also include a conforming element 1403 composed of a soft resilient material positioned on the side of the imaging device closest to the wearer, where such conforming element 1403 may adapt to the contour of head-gear or head of the user. In this way, the imaging device may be coupled with head-gear of such designs that do not enable other manners of connection with the imaging device.

FIG. 15 is a perspective view of the device 100 of FIG. 1, illustrating a direct link-up to a printer 1502 through a wireless connection or through a USB printer cable 1501. This allows data to be transferred without having to open the camera. The device 100 may have a transceiver or transmitter 132 that can electronically send, via a wireless signal, data files containing digital images.

FIG. 16 is a perspective view of the alternative embodiment as in FIG. 14, and is depicted as coupling, by means of fasteners 1401, to protective head-gear 1601 such as a bicycle helmet. The imaging device 1400 may attached to any variety of objects or gear worn on the head such as a protective helmet or a hat used for outdoor sports. It can be appreciated that the imaging device may also be attached to other items, such as the handlebars of a bicycle, a balloon, a kite, in combination with features such as depicted in FIG. 9 for remote image initiation. The waterproof or water resistant nature of the imaging device in all the embodiments described herein “ruggedizes” the imaging device in addition to making the camera ideal in rainy weather or in situations where the user may land in water such as boating, water skiing, wakeboarding or mountain biking. In this embodiment the camera unit would contain clamps, straps, bands or devices which allow the unit to securely attach to another object or to an object worn by the user.

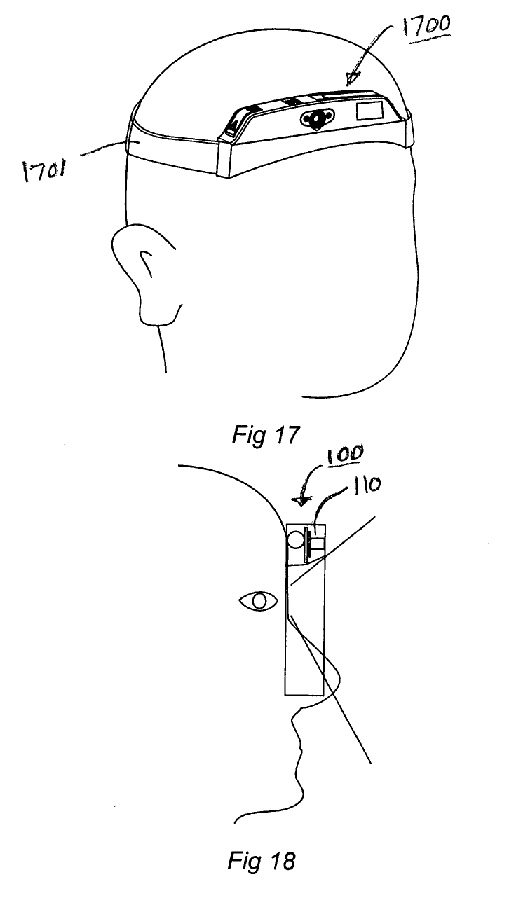

FIG. 17 is a perspective view of an alternative embodiment of the imaging device 1700 adapted for being worn directly on the users head, where the camera components are housed in a water proof or water resistant unit that may be worn directly on the head by use of a strap 1701 or band. This embodiment is ideal for use with smaller goggles worn by swimmers. This embodiment has additional uses as the strap or band may fit over or around a protective helmet or a hat used for outdoor sports. The waterproof nature of the imaging device 1700 would help to cushion to components under rugged use in addition to making the imaging ideal in rainy weather or in situations where the user may be active both on land and in water such as a tri-athlete.

FIG. 18 is a schematic side view of the device 100 of FIG. 1, illustrating the positioning of the lens 110 relative to the users' eyes. As noted above, the lens is positioned on the forehead in line with the nose and just above the eyes. The eyes are not obstructed with this positioning. The close proximity of the lens 110 to the eyes allows the user to record an image with the camera that is similar to what is in the user's field of vision. By use of the cross hairs 107 on the goggles, a user may approximate the image that will be recorded when the camera is activated.

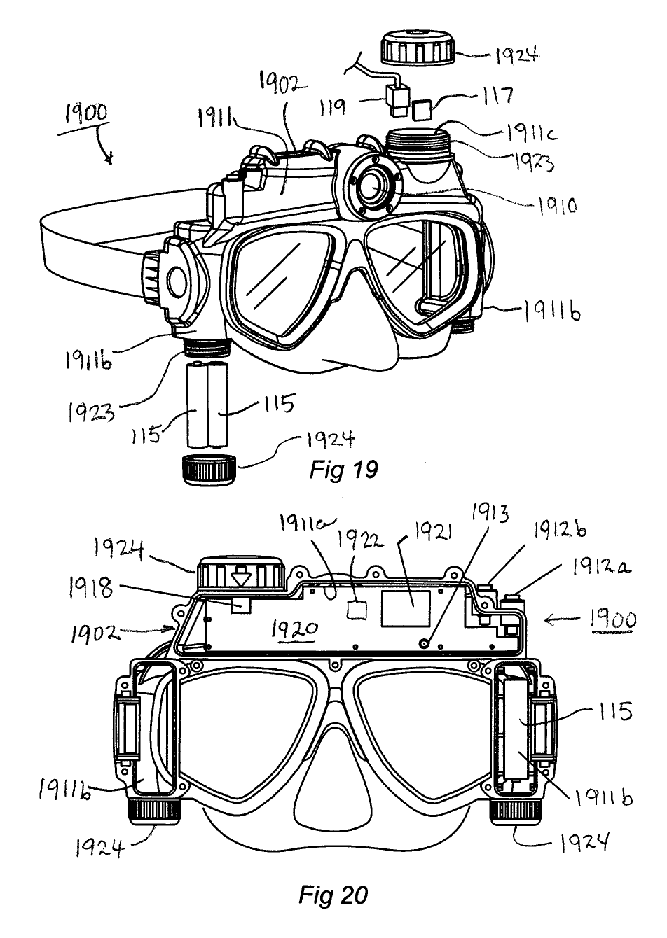

FIGS. 19-21 illustrating another preferred embodiment in the form of a wearable, waterproof imaging device 1900. Illustrated imaging device 1900 is similar to the imaging devices described above, but with certain significant variations. The frame or housing 1902 has a main compartment 1911a and several user-openable compartments 1911b, 1911c. The main compartment 1911a is permanently sealed except for a USB port 1918 that is itself sealed within a user openable compartment 1911c

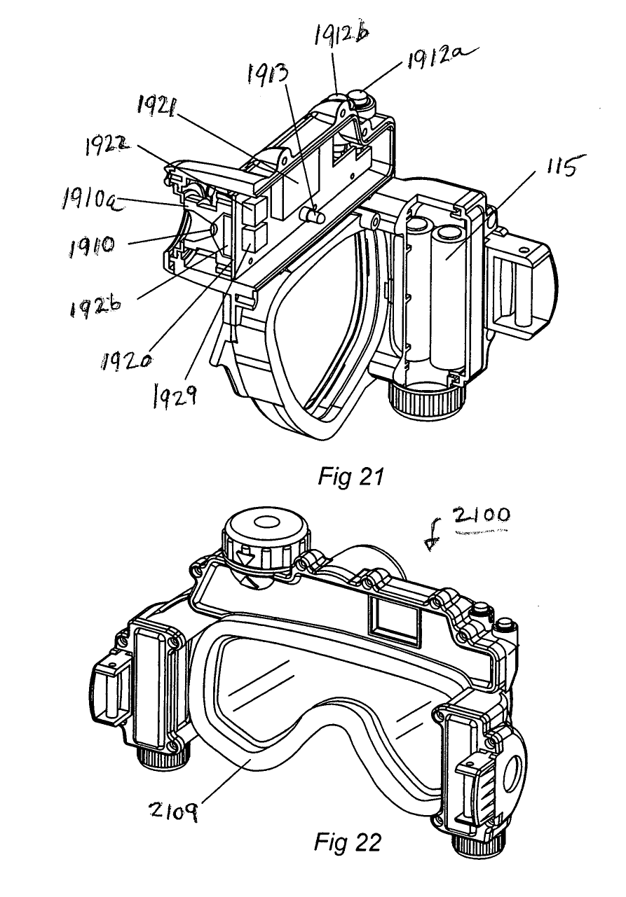

The main compartment 1911a, as shown in FIGS. 20 and 21, houses a printed circuit board (PCB) 1920 on which camera elements or components may be mounted. These components may include a lens 1910, a lens housing 1910a, an image-capturing sensor 1926, a microprocessor chip 1922, a built-in flash memory 1929, an LCD screen 1921, an LED indicator light 1913, and a USB connector/port 1918. The device 1900 also includes manually operable/depressible buttons, select/shutter button 1912a and on-off/mode button 1912b.

The illustrated openable compartments include one generally cylindrical, upright compartment 1911b at each side of the frame 1902 adjacent to a temple of the wearer. Compartments 1911b have their entrance openings 1923 at their lower ends. At least one of these side compartments 1911b may be arranged for receiving one or more batteries 115. This wrap-around arrangement of the frame 1902 provides a more balanced and lower distribution of weight on the head of the wearer.

Another illustrated openable compartment 1911c with an upwardly opening entrance 1923 is shown in FIG. 19 removably receiving a removable memory chip 117, and a USB connector 119 of a cable to a peripheral device such as a PC or a printer (FIG. 19).

The illustrated openable compartments 1911 are each provided with a threaded entrance opening 1922 onto which a threaded cap 1924 may be removably screwed to provide a watertight closure for the compartment.

FIG. 22 illustrates another preferred embodiment in the form of a wearable, waterproof imaging device 2100 particularly adapted to use when skiing, water surfing or the like. The face engaging gasket 108 is replaced by a soft compressible peripheral rib 2109.

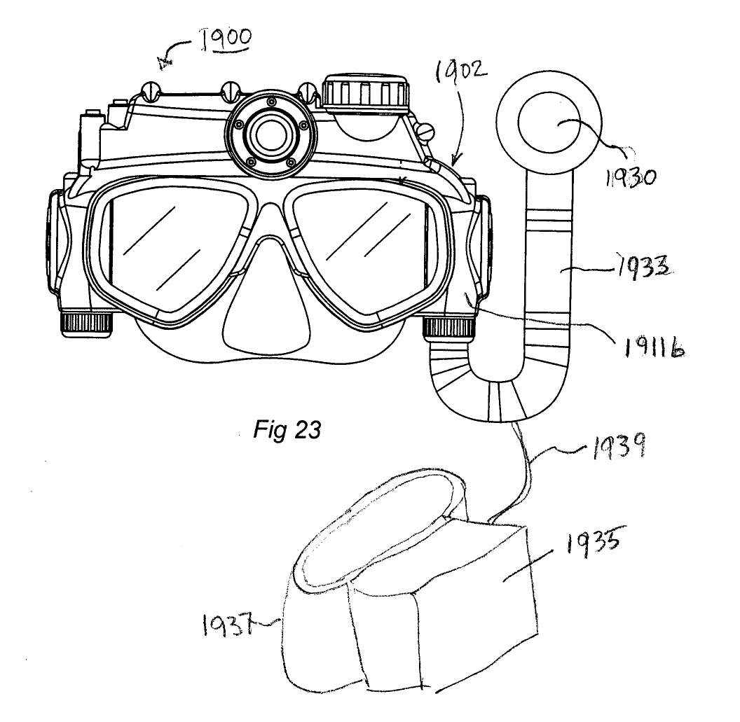

FIG. 23 illustrates the device of FIG. 19 with the addition of an adjustable underwater light 1930. The illustrated light 1930 is mounted on the opposite side of the housing 1902 from the batteries to balance the weight distribution. The light 1930 may be mounted on a bendable arm 1933 which has a screw attachment to the lower end of a frame compartment 1911b. The arm 1933 may be manually bent to point the light in a desired direction. The light 1930 may be a strobe-type light.

The battery or batteries for the light 1930 may be contained in the compartment 1911b. However, to provide adequate power over an extended period of time, large and/ or many batteries would be required. The space needed would greatly increase the size of the housing as well as its weight on the user's head, which is undesirable. Therefore, the batteries for the light could be housed in a separate housing 1935 that might be mounted as by a strap 1937 on the user's body, arm or leg. A suitable waterproof electrical cord 1939 could be provided between the housing 1935 and the light 1930

As depicted and discussed, the camera is suitable for use as an underwater camera combined with an athletic device, although other applications exist. The primary focus is for creating recreational devices with the possibility of being configured for more professional uses. Professional uses may include scuba diving below 10 feet or incorporating higher quality camera components for use in underwater photography or scientific exploration. The camera may or may not include infrared, USB or other wireless components to transfer the image data to a computer or printer. The electronic components may be controlled directly through buttons or levers located on the surface of the camera or by a remote control device configured into a glove or finger apparatus with a button to trigger the digital camera features and flash to further improve the device for safer activity. The device may be configured for delivering sound to the wearer, for digital video capture, for audio capture and other media capture and delivery.

The invention is not limited to the illustrated embodiments but is defined by the following claims.

What is claimed is:

1. A wearable, waterproof camera and goggle device comprising:
(a) a plurality of elements related to a digital camera;
(b) a goggle frame having at least one viewing window and configured to be removably worn upon the head of a user so that the user can see through the window, said frame also serving as a waterproof housing having at least two interior compartments for receiving and supporting therein said camera-related elements, said compartments being sealed to protect said camera-related elements from ambient water, at least one of said compartments being permanently sealed to prevent it from being opened by the user, at least one of said compartments being selectively openable by the user to provide access to at least one of the camera-related elements therein; and
(c) control means mounted on said frame and operatively connected to the camera so as to control the operation of the camera, said control means being manually operable from externally of said device and being sealed to prevent ambient water from reaching said camera-related elements.

2. The device of claim 1 wherein said elements in said permanently sealed compartment including a digital camera sensor.

3. The device of claim 1 wherein said openable compartment includes a threaded entrance and a threaded closure member for removably being threaded by the user to said entrance to seal said compartment.

4. The device of claim 1 wherein said openable compartment is constructed and arranged to receive, removably support, and electrically connect to a removable memory element.

5. The device of claim 1 wherein said openable compartment is constructed and arranged to receive and detachably connect to a data transfer cable.

6. The device of claim 1 wherein said openable compartment is constructed and arranged to receive, removably support, and electrically connect to at least one power-providing battery, said device including an electrical conduit extending from said openable battery receiving compartment to at least one of said camera-related elements.

7. The device of claim 1 wherein said housing has a shallow elongated configuration that extends transversely generally across the front of the user's forehead, with the window located generally in front of the user's eyes.

8. The device of claim 1 also including camera lens mounted on the front of said frame generally centrally side-to-side.

9. The device of claim 1 wherein said goggle frame includes a skirt made of a silicon or rubber-like material for engaging the face of the wearer.

10. The device of claim 1 including a relatively soft flexible compliant seal extending around the periphery of the housing to engage the user's face to seal off the area in front of the user's eyes.

11. A wearable camera and goggle device having at least one openable compartment, said device comprising:
(a) a plurality of elements related to a digital camera;
(b) a goggle frame having at least one viewing window and configured to be removably worn upon the head of a user so that the user can see through the window, said frame also serving as a waterproof housing for said camera-related elements, said housing providing at least one sealed interior compartment for receiving, supporting, and removably connecting to at least one camera-related element, said at least one of said compartments being selectively openable by the user to provide access to said at least one camera related-element; and
(c) control means mounted on said frame and operatively connected to the camera elements so as to control the operation of the camera, said control means being manually operable by the user from externally of said device and being sealed to prevent ambient water reaching said camera elements.

12. The device of claim 11 wherein said camera-related element is a removable battery.

13. The device of claim 11 wherein said camera-related element is a removable memory element.

14. The device of claim 11 wherein said openable compartment includes a port for connecting to a data transfer cable.

15. A wearable camera and goggle device comprising:
(a) a plurality of elements related to a digital camera:
(b) a goggle frame having at least one viewing window and configured to be removably worn upon the head of a user so that the user can see through the window, said frame also serving as a waterproof housing having at least one interior compartment for receiving and supporting therein said camera-related element, said compartments being sealed to protect said camera-related element from ambient water, at least one of said compartments being permanently sealed to prevent it from being opened by the user; and
(c) separate, external operating means for communicating with at least one camera-related element in said permanently sealed compartment so as to control the operation of said element.

16. The device of claim 15 wherein said camera related element is a battery, said operating means being operable to charge the battery.

17. The device of claim 15 wherein said camera related element is a memory element, said operating means being operable to transfer data from said memory element.

18. The device of claim 15 wherein said operating means is selectively user operable to actuate the camera to take a picture.

19. The device of claim 15 wherein said operating means is in the form of a manually operable apparatus that includes structure for removably mounting the apparatus on the body of the user remote from the user's head.

20. A wearable, water-resistant camera device comprising:
a) a plurality of camera-related elements; and
b) a housing configured to be removably worn upon the head of a user, said housing providing at least one water-resistant interior compartment for receiving and supporting therein said camera-related elements, said compartment being closed and water-resistant to protect said camera-related elements from ambient liquid,
said housing comprising (i) a mid section that is elongated and is positioned, when the camera device is being worn, to extend from side to side across the user's forehead, and (ii) a pair of side sections that each extend generally rearwardly from one end of said mid section generally adjacent to a temple of the user.

21. The device of claim 20 wherein said mid-section contains a compartment.

22. The device of claim 21 wherein at least one of said side sections contains an ancillary compartment.

23. The device of claim 22 wherein at least one of said ancillary compartments is constructed and arranged to receive and electrically connect to a battery.

24. The device of claim 23 wherein said camera device also includes an electrical conduit extending from said battery-containing ancillary compartment to at least one of said camera-related elements in said main compartment.

25. The device of claim 23 wherein a light is supported at the side of said frame opposite said battery receiving compartment.

26. The device of claim 1 including a signal means that is activated when a picture is taken to provide a sensory signal that can be sensed by the user to advise the user that a picture was taken

27. The device of claim 1 further including an underwater electrical light mounted on said frame, a separate container for at least one battery, said container being adapted and arranged for being mounted on the body, arm or leg of the user, and a waterproof electrical cord connected between said light and said container so as to conduct electrical power from a battery in said container to said light.

28. The device of claim 19 wherein said manually operable apparatus is mounted adjacent to a hand of the user so that it may be readily operated by a hand of the user

29. The device of claim 1 further including at least one water-proof ear plug for being received in the ear of the user, a music-providing apparatus in said housing, and means for transmitting music provided by said apparatus to said ear plug.
